(19) United States
(12) Patent Application Publication
(10) Pub. No.: US 2020/0150684 A1
(43) Pub. Date: May 14, 2020

(54) METHOD AND APPARATUS FOR CONTROLLING AUTONOMOUS VEHICLE

(71) Applicant: LG Electronics Inc., Seoul (KR)

(72) Inventor: Cheolseung KIM, Seoul (KR)

(21) Appl. No.: 16/743,759

(22) Filed: Jan. 15, 2020

(30) Foreign Application Priority Data
Oct. 21, 2019 (KR) 10-2019-0130670

(51) Int. Cl. G05D 1/02; G08G 1/00; G08G 1/01; H04B 7/06; H04W 4/40

(52) U.S. Cl. CPC G05D 1/0287; G08G 1/22; G08G 1/0145; G05D 1/0285; G05D 2201/0213; H04B 7/0617; H04W 4/40; G05D 2201/0212; H04B 7/0626

(57) ABSTRACT

Disclosed is a data communication method. The data communication method performed in a computing device includes transmitting driving-related information of a vehicle to infrastructure, and performing communication between the vehicle and the infrastructure based on at least one of beam information corresponding to the driving-related information. One or more of an autonomous vehicle, a user equipment, and a server of the present disclosure may be associated with an artificial intelligence (AI) module, an unmanned aerial vehicle (UAV), a robot, an augmented reality (AR) device, a virtual reality (VR) device, a 5G service-related device, and the like.

### CROSS-REFERENCE TO RELATED APPLICATION

This application claims the benefit of Korean Patent Application No. 10-2019-0130670, filed on Oct. 21, 2019, in the Korean Intellectual Property Office, the disclosure of which is incorporated herein in its entirety by reference.

### BACKGROUND

### 1. Field

The present disclosure relates to a method and an apparatus for performing data communication in a computing device. One particular embodiment relates to a method and an apparatus for data communication to control communication between the vehicle and infrastructure to be successfully performed based on beam information corresponding to driving-related information of a vehicle.

### 2. Description of the Related Art

A vehicle may be classified as an internal combustion engine vehicle, an external combustion engine vehicle, a gas turbine vehicle, or an electric vehicle by a type of engine. An autonomous vehicle refers to a vehicle capable of driving on its own without manipulation of a driver or passenger. An autonomous driving system refers to a system for monitoring and controlling the autonomous vehicle to drive on its own.

In the autonomous driving system, a plurality of vehicles may form a platoon and the vehicles in the platoon may drive while forming a predetermined formation by exchanging information with each other through vehicle-to-everything (V2X) communication. There is need of a technology for enabling data to be successfully transmitted and received while data communication between a vehicle and infrastructure is not interrupted by platooning vehicles performing vehicle platooning.

### SUMMARY

An aspect provides a data communication technology for controlling communication between a vehicle and infrastructure to be successfully performed based on beam information corresponding to driving-related information of the vehicle. However, the technical goal of the present disclosure is not limited thereto, and other technical goals may be inferred from the following embodiments.

According to an aspect, there is provided a data communication method including transmitting driving-related information of a vehicle to infrastructure, and performing communication between the vehicle and the infrastructure based on at least one of beam information corresponding to the driving-related information.

According to another aspect, there is also provided a data communication method including receiving driving-related information of a vehicle, identifying pre-trained information satisfying a corresponding relationship equal to or greater than a predetermined criterion with respect to the driving-related information, and controlling platooning vehicle located in a lane adjacent to the vehicle by taking into consideration the pre-trained information.

According to another aspect, there is also provided a communication device including a communicator configured to receive driving-related information of a vehicle, and transmit control information for platooning vehicles, and a processor configured to identify at least one of beam information included in pre-trained information satisfying a correspondence relationship equal to or greater than a predetermined criterion with respect to the driving-related information, and, when a data transmission rate between the vehicle and the communication device based on the beam information does not satisfy a transmission rate required for a data profile, determine to transmit control information to the platooning vehicles.

According to an aspect, the platooning vehicles may be vehicles performing vehicle platooning between the vehicle and the communication device. The beam information may include at least one of horizontal angle information, vertical angle information, or power information for beamforming that uses a millimeter wave bandwidth. The driving-related information may include at least one of the following: location information of the vehicle, shape information of the vehicle, or speed information of the vehicle, location information of the platooning vehicles located in a lane adjacent to the vehicle, shape information of the platooning vehicles, and speed information of the platooning vehicles.

According to an aspect, the control information may include information on spacing between the platooning vehicles, and the information on the spacing between the platooning vehicles is determined by taking into consideration the data transmission rate and a beam pattern according to the beam information. The at least one of the beam information may include uplink-related beam information or downlink-related beam information. The uplink-related beam information is identified based on information on a channel state that is identified by the communication device based on a reference signal transmitted from another vehicle. The downlink-related information may be identified based on information on channel state that is reported by the another device based on a reference signal transmitted from the communication device.

Details of other embodiments are included in the detailed description and the accompanying drawings.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device 100 according to an embodiment of the present disclosure;

FIG. 2 illustrates an AI server 200 according to an embodiment of the present disclosure;

FIG. 3 illustrates an AI system 1 according to an embodiment of the present disclosure;

FIG. 4 illustrates a block diagram illustrating a configuration of a wireless communication system to which methods proposed in the present disclosure are applicable;

FIG. 5 illustrates an example of physical channels used in a 3GPP system and general signal transmission;

FIG. 6 illustrates an example of basic operations of an autonomous vehicle and a 5G network in a 5G communication system;

FIG. 7 illustrates an example of basic operations between vehicles using 5G communication;

FIG. 8 is a control block diagram of an autonomous vehicle according to an embodiment;

FIG. 9 is an example of vehicle-to-everything (V2X) communication to which the present disclosure is applicable;

FIG. 10 is a diagram illustrating a relationship among a server, an RSU, and a vehicle according to an embodiment;

FIG. 11 is a diagram illustrating beam information radiated from an RSU according to an embodiment;

FIG. 12 is a diagram illustrating a vehicle performing vehicle platooning according to an embodiment;

FIG. 13 is a diagram illustrating a road side unit (RSU), a platooning vehicle, and a vehicle driving in an adjacent lane according to an embodiment;

FIG. 14 is a plan view of an RSU, a platooning vehicle, and a vehicle driving in an adjacent lane according to an embodiment;

FIG. 15 is a plan view of an RSU, platooning vehicles, and a vehicle according to another embodiment;

FIG. 16 is a diagram illustrating a control procedure for platooning vehicles according to an embodiment; and

FIG. 17 is a flowchart of a data communication method according to an embodiment.

### DETAILED DESCRIPTION

Exemplary embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operations to be performed on the computer or other programmable apparatus to produce a computer implemented process such that the instructions which are executed on the computer or other programmable apparatus provide operations for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function may be used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

In this case, an autonomous vehicle may be seen as a robot having an autonomous driving function.

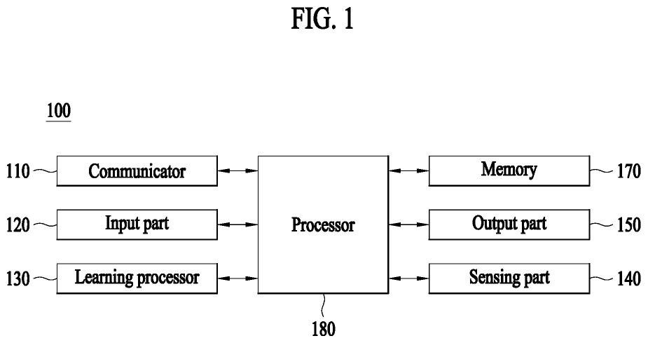

FIG. 1 illustrates an AI device 100 according to an embodiment of the present disclosure.

The AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, a terminal 100 may include a communicator 110, an input part 120, a learning processor 130, a sensing part 140, an output part 150, a memory 170, and a processor 180, for example.

The communicator 110 may transmit and receive data to and from external devices, such as other AI devices 100a to 100e and an AI server 200, using wired/wireless communication technologies. For example, the communicator 110 may transmit and receive sensor information, user input, learning models, and control signals, for example, to and from external devices.

In this case, the communication technology used by the communicator 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

The input part 120 may acquire various types of data.

In this case, the input part 120 may include a camera for the input of an image signal, a microphone for receiving an audio signal, and a user input part for receiving information input by a user, for example. Here, the camera or the microphone may be handled as a sensor, and a signal acquired from the camera or the microphone may be referred to as sensing data or sensor information.

The input part 120 may acquire, for example, input data to be used when acquiring an output using learning data for model learning and a learning model. The input part 120 may acquire unprocessed input data, and in this case, the processor 180 or the learning processor 130 may extract an input feature as pre-processing for the input data.

The learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

In this case, the learning processor 130 may perform AI processing along with a learning processor 240 of the AI server 200.

In this case, the learning processor 130 may include a memory integrated or embodied in the AI device 100. Alternatively, the learning processor 130 may be realized using the memory 170, an external memory directly coupled to the AI device 100, or a memory held in an external device.

The sensing part 140 may acquire at least one of internal information of the AI device 100 and surrounding environmental information and user information of the AI device 100 using various sensors.

In this case, the sensors included in the sensing part 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

The output part 150 may generate, for example, a visual output, an auditory output, or a tactile output.

In this case, the output part 150 may include, for example, a display that outputs visual information, a speaker that outputs auditory information, and a haptic module that outputs tactile information.

The memory 170 may store data which assists various functions of the AI device 100. For example, the memory 170 may store input data acquired by the input part 120, learning data, learning models, and learning history, for example.

The processor 180 may determine at least one executable operation of the AI device 100 based on information determined or generated using a data analysis algorithm or a machine learning algorithm. Then, the processor 180 may control constituent elements of the AI device 100 to perform the determined operation.

To this end, the processor 180 may request, search, receive, or utilize data of the learning processor 130 or the memory 170, and may control the constituent elements of the AI device 100 so as to execute a predictable operation or an operation that is deemed desirable among the at least one executable operation.

In this case, when connection of an external device is necessary to perform the determined operation, the processor 180 may generate a control signal for controlling the external device and may transmit the generated control signal to the external device.

The processor 180 may acquire intention information with respect to user input and may determine a user request based on the acquired intention information.

In this case, the processor 180 may acquire intention information corresponding to the user input using at least one of a speech to text (STT) engine for converting voice input into a character string and a natural language processing (NLP) engine for acquiring natural language intention information.

In this case, at least a part of the STT engine and/or the NLP engine may be configured with an artificial neural network learned according to a machine learning algorithm. Then, the STT engine and/or the NLP engine may have learned by the learning processor 130, may have learned by the learning processor 240 of the AI server 200, or may have learned by distributed processing of the processors 130 and 240.

The processor 180 may collect history information including, for example, the content of an operation of the AI device 100 or feedback of the user with respect to an operation, and may store the collected information in the memory 170 or the learning processor 130, or may transmit the collected information to an external device such as the AI server 200. The collected history information may be used to update a learning model.

The processor 180 may control at least some of the constituent elements of the AI device 100 in order to drive an application program stored in the memory 170. Moreover, the processor 180 may combine and operate two or more of the constituent elements of the AI device 100 for the driving of the application program.

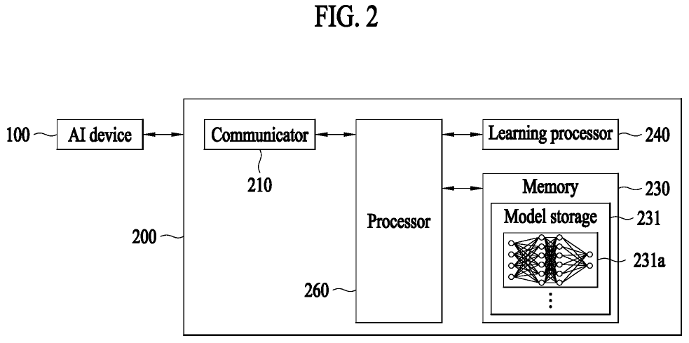

FIG. 2 illustrates the AI server 200 according to an embodiment of the present disclosure.

Referring to FIG. 2, the AI server 200 may refer to a device that causes an artificial neural network to learn using a machine learning algorithm or uses the learned artificial neural network. Here, the AI server 200 may be constituted of multiple servers to perform distributed processing, and may be defined as a 5G network. In this case, the AI server 200 may be included as a constituent element of the AI device 100 so as to perform at least a part of AI processing together with the AI device 100.

The AI server 200 may include a communicator 210, a memory 230, a learning processor 240, and a processor 260, for example.

The communicator 210 may transmit and receive data to and from an external device such as the AI device 100.

The memory 230 may include a model storage 231. The model storage 231 may store a model (or an artificial neural network) 231a which is learning or has learned via the learning processor 240.

The learning processor 240 may cause the artificial neural network 231a to learn learning data. A learning model may be used in the state of being mounted in the AI server 200 of the artificial neural network, or may be used in the state of being mounted in an external device such as the AI device 100.

The learning model may be realized in hardware, software, or a combination of hardware and software. In the case in which a part or the entirety of the learning model is realized in software, one or more instructions constituting the learning model may be stored in the memory 230.

The processor 260 may deduce a result value for newly input data using the learning model, and may generate a response or a control instruction based on the deduced result value.

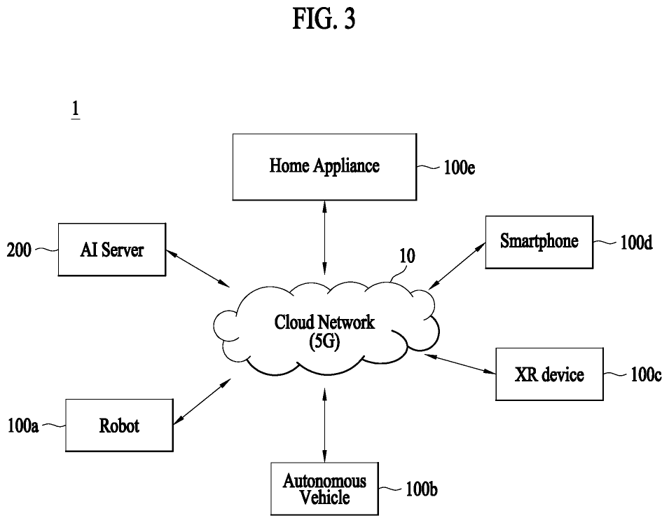

FIG. 3 illustrates an AI system 1 according to an embodiment of the present disclosure.

Referring to FIG. 3, in the AI system 1, at least one of an AI server 200, a robot 100a, an autonomous vehicle 100b, an XR device 100c, a smart phone 100d, and a home appliance 100e is connected to a cloud network 10. Here, the robot 100a, the autonomous vehicle 100b, the XR device 100c, the smart phone 100d, and the home appliance 100e, to which AI technologies are applied, may be referred to as the AI devices 100a to 100e.

The Cloud network 10 may constitute a part of a cloud computing infra-structure, or may mean a network present in the cloud computing infra-structure. Here, the cloud network 10 may be configured using a 3G network, a 4G or long term evolution (LTE) network, or a 5G network, for example.

That is, the respective devices 100a to 100e and 200 constituting the AI system 1 may be connected to each other via the cloud network 10. In particular, the respective devices 100a to 100e and 200 may communicate with each other via a base station, or may perform direct communication without the base station.

The AI server 200 may include a server which performs AI processing and a server which performs an operation with respect to big data.

The AI server 200 may be connected to at least one of the robot 100a, the autonomous vehicle 100b, the XR device 100c, the smart phone 100d, and the home appliance 100e, which are AI devices constituting the AI system 1, via the cloud network 10, and may assist at least a part of AI processing of the connected AI devices 100a to 100e.

In this case, instead of the AI devices 100a to 100e, the AI server 200 may cause an artificial neural network to learn according to a machine learning algorithm, and may directly store a learning model or may transmit the learning model to the AI devices 100a to 100e.

In this case, the AI server 200 may receive input data from the AI devices 100a to 100e, may deduce a result value for the received input data using the learning model, and may generate a response or a control instruction based on the deduced result value to transmit the response or the control instruction to the AI devices 100a to 100e.

Alternatively, the AI devices 100a to 100e may directly deduce a result value with respect to input data using the learning model, and may generate a response or a control instruction based on the deduced result value.

Hereinafter, various embodiments of the AI devices 100a to 100e, to which the above-described technology is applied, will be described. Here, the AI devices 100a to 100e illustrated in FIG. 3 may be specific embodiments of AI device 100 illustrated in FIG. 1.

The autonomous vehicle 100b may be realized into a mobile robot, a vehicle, or an unmanned aerial vehicle, for example, through the application of AI technologies.

The autonomous vehicle 100b may include an autonomous driving control module for controlling an autonomous driving function, and the autonomous driving control module may mean a software module or a chip realized in hardware. The autonomous driving control module may be a constituent element included in the autonomous vehicle 100b, but may be a separate hardware element outside the autonomous vehicle 100b so as to be connected to the autonomous vehicle 100b.

The autonomous vehicle 100b may acquire information on the state of the autonomous vehicle 100b using sensor information acquired from various types of sensors, may detect (recognize) the surrounding environment and an object, may generate map data, may determine a movement route and a driving plan, or may determine an operation.

Here, the autonomous vehicle 100b may use sensor information acquired from at least one sensor among a lidar, a radar, and a camera in the same manner as the robot 100a in order to determine a movement route and a driving plan.

In particular, the autonomous vehicle 100b may recognize the environment or an object with respect to an area outside the field of vision or an area located at a predetermined distance or more by receiving sensor information from external devices, or may directly receive recognized information from external devices.

The autonomous vehicle 100b may perform the above-described operations using a learning model configured with at least one artificial neural network. For example, the autonomous vehicle 100b may recognize the surrounding environment and the object using the learning model, and may determine a driving line using the recognized surrounding environment information or object information. Here, the learning model may be directly learned in the autonomous vehicle 100b, or may be learned in an external device such as the AI server 200.

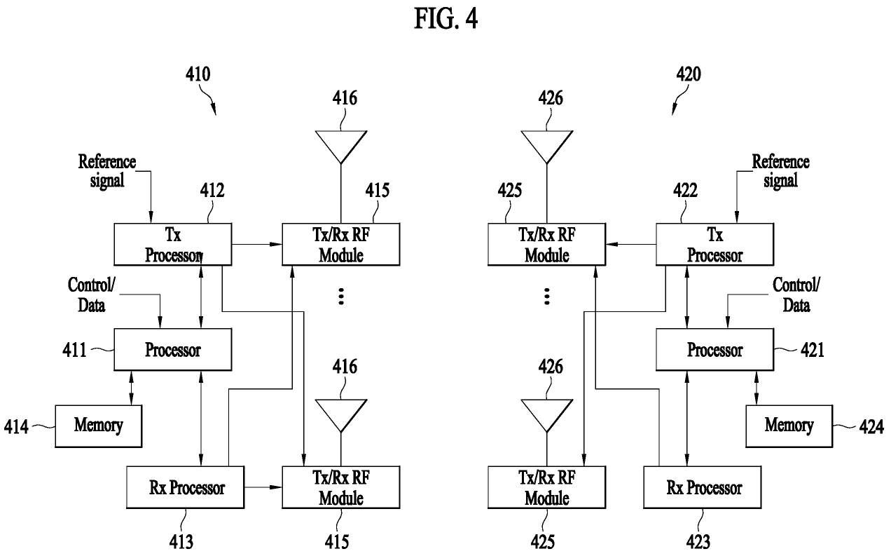

FIG. 4 illustrates a block diagram illustrating a configuration of a wireless communication system to which methods proposed in the present disclosure are applicable.

Referring to FIG. 4, a device including an autonomous driving module (e.g., an autonomous driving device) may be defined as a first communication device 410, and a processor 411 may perform detailed operations of autonomous driving. Here, the autonomous driving device may include an autonomous vehicle. A 5G network including another vehicle in communication with the autonomous driving device may be defined as a second communication device 421, and a processor 421 may perform detailed autonomous driving operation. Alternatively, the 5G network may be referred to as a first communication device and the autonomous driving device may be referred to as a second communication device. For example, the first communication device or the second communication device may be a network node, a transmitting terminal, a receiving terminal, a wireless device, a wireless communication device, an autonomous driving device, etc.

For example, a terminal or a user equipment (UE) may include a vehicle, a mobile phone, a smart phone, a laptop computer, a digital broadcast terminal, a personal digital assistant (PDA), a portable multimedia player (PMP), a navigation system, a slate PC, a tablet PC, an ultrabook, a wearable device (e.g., a smartwatch, a smart glass, a head-mounted display (HMD), etc. Referring to FIG. 4, the first communication device 410 and the second communication device 420 includes processors 411 and 421, memories 414 and 424, one or more TX/RX radio frequency (RF) modules 415 and 425, Tx processors 412 and 422, Rx processors 413 and 423, and antennas 416 and 426. The Tx/RX modules may be referred to as transceivers. Each Tx/Rx module 415 transmits a signal through an antenna thereof. The processor implements the aforementioned functions, processes, and/or methods. The processor 421 may be associated with the memory 424 for storing program codes and data. The memory may be referred to as a computer readable medium. More specifically, in DL (communication from the first communication device to the second communication), the TX processor 412 implements various signal processing functions for the L1 layer (that is, physical layer). The RX processor implements various signal processing function for the L1 layer (that is, physical layer).

UL (communication from the second communication device to the first communication device) is performed in the first communication device 410 in a manner similar to the foregoing description regarding a receiver function in the second communication device 420. Each Tx/Rx module 425 receives a signal through an antenna 426 thereof. Each Tx/Rx module provides an RF carrier and information to the RX processor 423. The processor 421 may be associated with the memory 424 for storing program codes and data. The memory may be referred to as a computer readable medium.

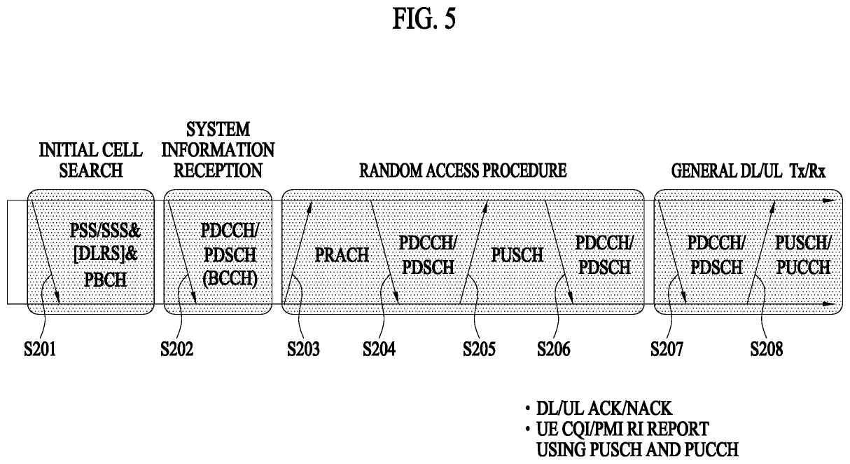

FIG. 5 illustrates an example of physical channels used in the 3GPP system and general signal transmission. In a wireless communication system, a UE receives information from a base station (BS) through a downlink (DL), and also transmits information to the BS through an uplink (UL). Examples of information transmitted from or received in the BS and the UE include data and various kinds of control information, and various physical channels exist depending on a type and usage of the information transmitted from or received in the BS and the UE.

When powered on or when a UE initially enters a cell, the UE performs initial cell search involving synchronization with a BS in operation S101. For initial cell search, the UE synchronizes with the BS and acquire information such as a cell Identifier (ID) by receiving a primary synchronization channel (P-SCH) and a secondary synchronization channel (S-SCH) from the BS. Then the UE may receive broadcast information from the cell on a physical broadcast channel (PBCH). In the meantime, the UE may identify a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in operation S102.

Meanwhile, if the UE initially accesses the BS or if there is no radio resource signal transmission, the UE may perform a random access procedure (RACH) to access the BS in operation S203 to S206. To this end, the UE may transmit a specific sequence through a physical random access channel (PRACH) as a preamble in operations S203 and S205) and receive a response message to the preamble through the PDCCH and the PDSCH associated with the PDCCH. In the case of a contention-based random access procedure, the UE may additionally perform a contention resolution procedure in operation S206

After the foregoing procedure, the UE may receive a PDCCH/PDSCH in operation S207 and transmit a physical uplink shared channel (PUSCH)/physical uplink control channel (PUCCH) in operation S208, as a general downlink/uplink signal transmission procedure. In particular, the UE may receive downlink control information (DC) through the PDCCH. Here, the DCI may include control information such as resource allocation information for the UE and a different format may be applied to the DCI according to a purpose of use.

Meanwhile, control information transmitted from the UE to the BS or received by the UE from the BS through an uplink may include uplink/downlink acknowledgement/negative-acknowledgement (ACK/NACK) signal, a channel quality indicator (CQI), a precoding matrix index (PMI), a rank indicator (RI), etc. The UE may transmit control information such as the aforementioned CQI/PMI/RI and the like through the PUSCH and/or PUCCH.

A. Beam Management (BM) procedure of the 5G communication System

The BM procedure may be classified into (1) a DL BM process using an SSB or a CSI-RS and (2) a UL BM process using a sounding reference signal (SRS). In addition, each BM procedure may include Tx beam sweeping for determining a Tx beam and Rx beam sweeping for determining an Rx beam.

A DL BM procedure using an SSB will be described.

Setting a beam report using an SSB may be performed upon channel state information (CSI)/beam setting in an RRC CONNECTED state.
An UE receives CSI-ResourceConig IE, including a CSI-SSB-ResourceSetList for SSB resources to be used for BM, from a BS. The CSI-SSB-ResourceSetList, which is an RRC parameter, represents a list of SSB resources to be used in a single resource set for beam management and beam reporting. Here, the SSB resource set may be set to be {SSBx1, SSBx2, SSBx3, SSBx4, ˜}. An SSB index may be defined as 0 to 63.
The UE receives signals on the SSB resources from the BS based on the CSI-SSB-ResourceSetList.
When CSI-RS reportConfig associated with reporting an SS/PBCH Resource Block Indicator (SSBRI) and reference signal received power (RSRP), the UE reports the best SSBRI and RSRP corresponding thereto to the BS. For example, reportQuantity of the CSI-RS reportConfig IE is set to “ssb-Index-RSRP”, the UE reports the best SSBRI and the RSRP corresponding to the best SSBRI to the BS.

When a CSI-RS resource is set to an OFDM symbol(s) identical to the SSB is set and when “QCL-TypeD” is applicable, the UE may assume that the CSI-RS and the SSB are quasi co-located (QCL) with each other in view of “QCL-TypeD”. Here, the QCL-typeD may mean that antenna ports are QCL with each other in view of a spatial Rx parameter. When the UE receives signals from a plurality of DL antenna ports in a QCL-TypeD relationship, there is no problem even though the same reception beam is applied.

Next, a DL BM procedure using a CSI-RS will be described.

An Rx beam determining (or refining) procedure performed by a UE using a CSI-RS, and a Tx beam sweeping procedure performed by a BS will be described sequentially. In the Rx beam determining procedure performed by the UE, a repetition parameter is set to “ON.” In the Tx beam sweeping procedure performed by the BS, the repetition parameter is set to “OFF.”

First, the Rx beam determining procedure performed by the UE will be described.
The UE receives an NZP CSI-RS resource set IE, including an RRC parameter regarding “repetition”, from a BS through RRC signaling. Here, the RRC parameter “repetition” is set to “ON.”
The UE repeatedly receives, from different OFDM symbols through the same Tx beam (or a DL spatial domain transmission filter), signals on a resource(s) in the CSI-RS resource set of which the RRC parameter “repetition” is set to “ON”.
The UE determines an RX beam of its own.
The UE omits CSI reporting. That is, when the RRC parameter “repetition” is set to “ON”, the UE may omit CSI reporting.

Next, the Tx beam determining procedure performed by the BS will be described.
The UE receives an NZP CSI-RS resource set IE including an RRC parameter regarding “repetition” from the BS through RRC signaling. Here, the RRC parameter “repetition” is set to “OFF” and associated with the Tx beam sweeping procedure performed by the BS.
The UE receives, through different Tx beams (or a DL spatial domain transmission filter, signals on resources in a CSI-RS resource set of which the RRC parameter “repetition’ is set to “OFF.”
The UE selects (or determines) the best beam.
The UE reports an ID (e.g., CSI-RS resource indicator (CRI)) for the selected beam and relevant quality information (e.g., RSRP) to the BS. That is, when a CSI-RS is transmitted for BM, the UE reports CRI and RSRP regarding the CRI to the BS.

Next, a UL BM procedure using a sounding reference signal (SRS) will be described.
The UE receives, from the BS, RRC signaling (e.g., an SRS-Config IE) including a usage parameter set to “beam management” (RRC parameter). The SRS-Config IE is used for SRS transmission setting. The SRS-Config IE includes a list of SRS-resources and a list of SRS-ResourceSets. Each SRS resource set means a set of SRS-resources.
The UE determines Tx beamforming for an SRS resource to be transmitted based on SRS-SpatialRelation Info included in the SRS-Config IE. Here, the SRS-SpatialRelation Info is set for each SRS resource and indicates whether the same beamforming used in an SSB, a CSI-RS, or an SRS is to be applied for each SRS.
If SRS-SpatialRelationInfo is set in an SRS resource, the SRS resource is applied by applying the same beamforming used in the SSB, the CSI-RS, or the SRS. If SRS-SpatialRelationInfo is not set in the SRS resource, the UE arbitrarily determines Tx beamforming and transmits the SRS through the determined Tx beamforming.

Next, a beam failure recovery (BFR) procedure will be described.

In a beam-formed system, a radio link failure (RLF) may frequently occur due to rotation, movement, or beamforming blockage of the UE. In order to prevent frequent occurrence of RLF, BFR is supported in NR. The BFR is similar to a radio link failure recovery procedure and may be supported when the UE is aware of a new candidate beam(s). In order to detect a beam failure, the BS sets beam failure detection reference signals to the UE. When the number of beam failure indications from the physical layer of the UE reaches a threshold set by RRC signaling within a period set by RRC signaling of the BS, the UE declares a beam failure. After the beam failure is detected, the UE triggers a beam failure recovery by initiating a random access process on a PCell, and performs the beam failure recovery by selecting a suitable beam (when the BS provides dedicated random access resources for certain beams, the beams are prioritized by the UE). When the random access procedure is completed, it is considered completion of the beam failure recovery.

B. URLLC (Ultra-Reliable and Low Latency Communication)

URLLC transmission defined in NR may mean (1) a relatively low traffic volume, (2) a relatively low arrival rate, (3) an extremely low latency requirement (e.g., 0.5, 1 ms), (4) a relatively low transmission duration (e.g., 2 OFDM symbols), and (5) transmission of an emergency service/message, etc. In the case of a UL, in order to satisfy a more stringent latency requirement, multiplexing with other transmission (e.g., eMBB) scheduled prior to transmission of a specific type traffic (e.g., URLLC) may need to be performed. As one way regarding the above, information indicating that a specific resource will be preemptive may be given to a UE and the corresponding resource may be allowed to be used by an URLLC UE for UL transmission.

In NR, dynamic resource sharing between an eMBB and URLLC is supported. The eMBB and URLLC services may be scheduled on non-overlapping time/frequency resources, and URLLC transmission may be performed on resources scheduled for ongoing eMBB traffic. An eMBB UE may not be allowed to know whether PDSCH transmission by the corresponding UE is partially punctured, and the UE may not be allowed to decode a PDSCH due to corrupted coded bits. Given the above, the NR provides a preemption indication. The preemption indication may be referred to as an interrupted transmission indication.

Regarding the preemption indication, the UE receives a DownlinkPreemption IE through RRC signaling from the BS. When the DownlinkPreemption IE is received, the UE is set using an INT-RNTI, provided by a parameter int-RNTI in the DownlinkPreemption IE, in order to monitor a PDCCH that conveys DCI format 2_1. The UE is set with a set of serving cells according to an INT-ConfigurationPerServing Cell including a set of serving cell indices additionally provided by a servingCellID, and may be set with a set of locations for fields in DCI format 2_1 according to positionInDCI, may be set with an information payload size for DCI format 2_1 according to dci-PayloadSize, and may be set with an indication granularity of time-frequency resources according to timeFrequencySect.

The UE receives the DCI format 2_1 from the BS based on the DownlinkPreemption IE.

When the UE detects DCI format 2_! For a serving cell in a set of serving cells, the UE may assume that no transmission to the UE is not performing in PRBs and symbols indicated by the DCI format 2_1 among a set of PRBs and set of symbols in the last monitoring period before a monitoring period to which the DCI format2_1 belongs. For example, the U consider that a signal in a time-frequency resource indicated by a preemption is not DL transmission scheduled to the UE, and then the Ue decodes data based on signals received in other resource regions.

C. mMTC (Massive MTC)

Massive Machine Type Comunication (mMTC) is one of 5G scenarios for supporting a super connection service that indicates simultaneously communicating with a large number of UEs. In this environment, the UEs have an extremely low transmission rate and an extremely low mobility and thus perform communication intermittently. Thus, the mMTC aims to run the UEs for a long time at a low cost. Regarding mMTC technologies, 3gPP addresses MTC and narrow band (NB)-IoT.

The mMTC technologies have characteristics as follows: repetitive transmission through a PDCCH, a PUCCH, a physical downlink shared channel (PDSCH), a PUSCH, and the like; frequency hopping; retuning, a guard period, etc.

That is, repetitive transmission is performed through a PUSCH (or a PUCCH (especially a long PUCCH)) including particular information and a PDSCH (or a PDCCH) including a response to the particular information. The repetitive transmission is performed through frequency hopping. For the repetitive transmission, (RF) returning from a first frequency resource to a second frequency resource is performed in a guard period. The particular information and the response to the particular information may be transmitted/received through a narrowband (e.g., 6 resource block (RB) or 1 RB).

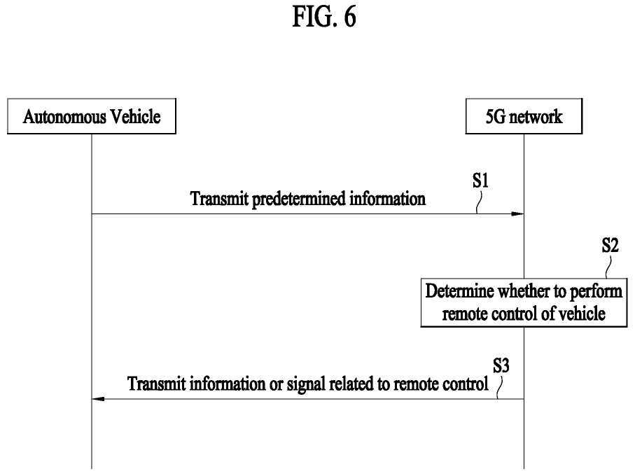

FIG. 6 illustrates an example of basic operations between an autonomous vehicle and a 5G network in a 5G communication system.

An autonomous vehicle transmits predetermined information to the 5G network in operation S1. The predetermined information may include autonomous driving-related information. The 5G network may determine whether to perform remote control of the vehicle in operation S2. Here, the 5G network may include a server or module for performing an autonomous driving-related remote control. The 5G network may transmit information (or a signal) related to the remote control to the autonomous vehicle in operation S3.

Here, application operations between the autonomous vehicle and the 5G network in the 5G communication system are as below. Hereinafter, operation of an autonomous vehicle using 5G communication will be described in detail based on FIGS. 1 and 2 and the above-described wireless communication technologies (e.g., BM procedure, URLLC, Mmtc, etc.).

First, a method described later and proposed in the present disclosure and a basic procedure of application operations applied to the eMBB technology will be described.

As shown in operations S1 and S3 of FIG. 6, in order for the autonomous vehicle to transmit and receive a signal, information, and the like with respect to the 5G network, the autonomous vehicle performs, prior to operation S1 of FIG. 6, an initial access procedure and a random access procedure with respect to the 5G network.

More specifically, the autonomous vehicle performs the initial access procedure with respect to the 5G network based on an SSB in order to acquire DL synchronization and system information. During the initial access procedure, a BM process and a beam failure recovery process may be added. In addition, while the autonomous vehicle receives a signal from the 5G network, a quasi-co location (QCL) relationship may be added.

In addition, the autonomous vehicle performs the random access procedure with respect to the 5G network in order to acquire UL synchronization and/or transmit a UL. Further, the 5G network may transmit a UL grant to schedule transmission of predetermined information to the autonomous vehicle. Accordingly, the autonomous vehicle transmits the predetermined information to the 5G network based on the UL grant. The 5G network transmits a DL grant to schedule transmission of a 5G processing result regarding the predetermined information to the autonomous vehicle. Accordingly, the 5G network may transmit remote control-related information (or signal) to the autonomous vehicle.

Next, a method proposed in the present disclosure and a basic procedure of application operations to which a URLLC technology of 5G communication is applied will be described.

As described above, after the initial access procedure and/or the random access procedure with respect to the 5G network, the autonomous vehicle may receive DownlinkPreemption IE from the 5G network. Then, based on DownlinkPreemption IE, the autonomous vehicle may receive DCI format 2_1 including a pre-emption indication from the 5G network. Then, the autonomous vehicle does not perform (or expect/assume) reception of eMBB data from a resource (a PRB and/or an OFDM symbol) indicated by the pre-emption indication. Thereafter, when there is a need to transmit predetermined information, the autonomous vehicle may receive a UL grant from the 5G network.

Next, a method hereinafter proposed in the present disclosure and a basic procedure of application operations to which the mMTC technology of 5G communication will be described.

The operations in FIG. 6 will be described mainly about part thereof that are changed upon application of the mMTC technology. In operation S1 of FIG. 6, an autonomous vehicle receive a UL grant from a 5G network in order to transmit predetermined information to a 5G network. The UL grant may include information on the repetition number of times the predetermined information is transmitted, and the predetermined information may be repeatedly transmitted based on the repetition number of times. That is, the autonomous vehicle transmits the predetermined information to the 5G network based on the UL grant. The repetition of transmission of the predetermined information is performed through frequency hopping, and first predetermined information may be transmitted from a first frequency resource and second predetermined information may be transmitted from a second frequency resource. The predetermined information may be transmitted through a narrowband of 6 resource block (RB) or 1 RB.

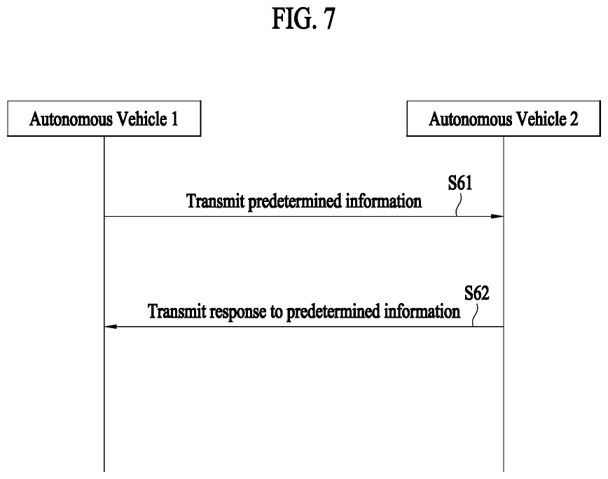

FIG. 7 illustrates an example of basic operations between vehicles using 5G communication.

A first vehicle transmits predetermined information to a second vehicle in operation S61. The second vehicle transmits a response to predetermined information to the first vehicle in operation S62.

Meanwhile, configuration of application operations between vehicles may vary depending on whether a 5G network directly (in sidelink communication transmission mode 3) or indirectly (in sidelink communication transmission mode 4) involves in resource allocation for the response to the predetermined information.

Next, application operations between vehicles through 5G communication will be described. First, a method in which the 5G network directly involves in resource allocation for signal transmission and/or reception between vehicles will be described.

The 5G network may transmit, to the first vehicle, DCI format 5A for scheduling mode-3 transmission (transmission over a physical sidelink control channel (PSCCH) and/or a physical sidelink shared channel (PSSCH)). Here, the PSCCH is a 5G physical channel for scheduling transmission of predetermined information, and the PSSCH is a 5G physical channel for transmitting the predetermined information. Then, the first vehicle transmits SCI format 1 for scheduling the transmission of the predetermined information to the second vehicle on the PSCCH. Then, the first vehicle transmits the predetermined information to the second vehicle on the PSSCH.

Next, a method in which the 5G network indirectly involves in resource allocation for signal transmission and/or reception will be described.

The first vehicle senses, on a first window, a resource for mode-4 transmission. Then, based on a result of the sensing, the first vehicle selects a resource for mode-4 transmission from a second window. Here, the first window refers to a sensing window, and the second window refers to a selection window. Based on the selected resource, the first vehicle transmits SCI format 1 for scheduling of transmission of predetermined information to the second vehicle on a PSCCH. Then, the first vehicle transmits the predetermined information to the second vehicle on a PSSCH.

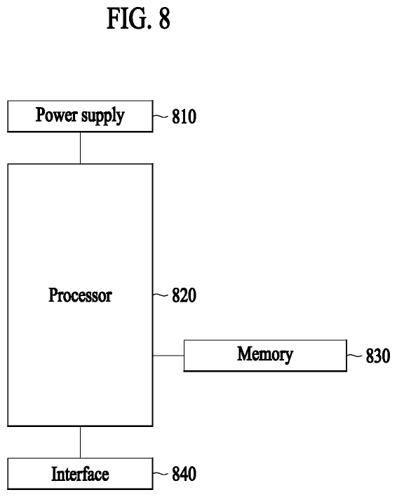

FIG. 8 is a control block diagram of an autonomous vehicle according to an embodiment.

Referring to FIG. 8, the autonomous vehicle may include a memory 830, a processor 820, an interface 840, and a power supply 810. Here, the foregoing description may apply to the memory 830, the processor 820, and the interface 840.

The memory 830 is electrically connected with the processor 820. The memory 830 may store basic data for units, control data for operation control of the units, and input/output data. The memory 830 may store data processed by the processor 820. The memory 830 may be implemented as at least one hardware element of an ROM, an ARM, an EPROM, a flash drive, or a hard drive. The memory 830 may store a variety of data for overall operation of an autonomous driving device, such as a program for processing or control of the processor 820. The memory 830 may be integrally formed with the processor 820. According to an embodiment, the memory 830 may be classified as a subordinate element of the processor 820.

The interface 840 may exchange a signal in a wired or wireless manner with at least one electronic device provided in a vehicle. The interface 840 may be formed as at least one of a communication module, a terminal, a pin, a cable, a port, a circuit, an element, or a device.

The power supply 810 may supply power to the autonomous driving device. The power supply 810 may receive power from a power source (e.g., a battery) included in the vehicle and supply the power to each unit of the autonomous driving device. The power supply 810 may operate in accordance with a control signal provided from a main ECU. The power supply 810 may include a switched-mode power supply (SMPS).

The processor 820 may be electrically connected with the memory 830, the interface 840, and the power supply 810 and exchange signals therewith. The processor may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and electric units for the implementation of other functions.

The processor 820 may be driven by power provided from the power supply 810.

While power is supplied from the power supply 810, The processor 820 may receive data, process the data, generate a signal, and provide the signal

The processor 820 may receive information from another electronic device provided in the vehicle, and the processor may provide a control signal to another electronic device provided in the vehicle.

The autonomous driving device may include at least one printed circuit board (PCB). The memory 830, the interface 840, the power supply 810, and the processor 820 may be electrically connected with the PCB.

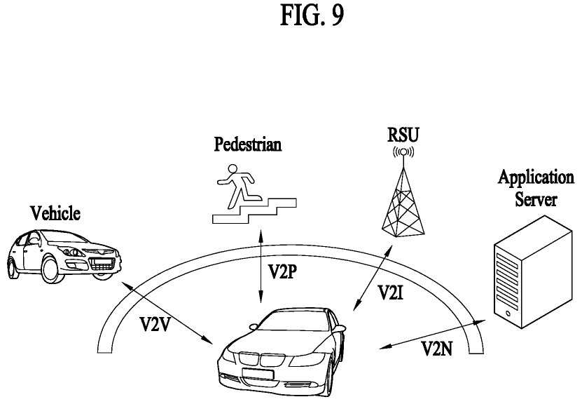

FIG. 9 is an example of vehicle-to-everything (V2X) communication to which the present disclosure is applicable.

V2X communication includes communication between a vehicle and any entity. For example, the V2X communication includes vehicle-to-vehicle (V2V) communication referring to communication between vehicles, vehicle-to-infrastructure (V2I) communication referring to communication between a vehicle and an eNB or road side unit (RSU), vehicle-to-pedestrian (V2P) communication referring to communication between a vehicle and a UE carried by a person (a pedestrian, a bicycler, a vehicle driver, or a passenger), and vehicle-to-network (V2N) communication.

The V2X communication may have the same meaning of V2X sidelink or NR V2X or may have a broader meaning including V2X sidelink or NR V2X.

The V2X communication may be applicable to various services, such as a front collision warning, an automatic parking system, a cooperative adaptive cruise control (CACC), a control loss warning, a traffic matrix warning, a vulnerable road user warning, an emergency vehicle alert, a speed warning when driving along a bent road, a road traffic control, etc.

The V2X communication may be provided through a PC5 interface or a Uu interface. In this case, in a wireless communication system that support the V2V communication, predetermined network entities for supporting communication between the vehicle and any entity may exist. For example, the network entity may be a BS (eNB), an RSU, a UE, an application server (e.g., a traffic safety server), or the like.

In addition, a UE performing the V2X communication may be not just a general handheld UE, but also a vehicle UE (V-UE), a pedestrian UE, an eNB type RSU, or a UE-type RSU, and a robot having a communication module.

The V2X communication may be performed directly between UEs or may be performed by the network entity(s). According to a method for performing the V2X communication, a V2X operation mode may be classified.

In order to prevent an operator or a third party from tracking a UE identifier in a region where V2X is supported, the V2X communication is required to support pseudonymity and privacy of a UE while a V2X application is in use.

Terms frequently used in the V2X communication are defined as below.
Road Side Unit (RSU): a road side unit (RSU) is a V2X service-capable apparatus capable of transmission and reception to and from a moving vehicle using V2I service. Furthermore, the RSU is a fixed infrastructure entity supporting a V2X application program and may exchange messages with other entities supporting a V2X application program. The RSU is a term frequently used in the existing ITS spec. The reason why this term is introduced into 3GPP spec. is for enabling the document to be read more easily in the ITS industry. The RSU is a logical entity that combines V2X application logic with the function of an eNB (called eNB-type RSU) or a UE (called UE-type RSU).
V2I Service: Type of V2X service and an entity having one side belonging to a vehicle and the other side belonging to infrastructure.
V2P Service: V2X service type in which one side is a vehicle and the other side is a device carried by a person (e.g., a portable UE carried by a pedestrian, bicycler, driver, or follow passenger).

V2X Service: 3GPP communication service type in which a transmission or reception device is related to a vehicle.

V2X enabled UE: UE supporting a V2X service.

V2V Service: Type of V2X service in which both sides of communication are vehicles.

V2V communication range: A direct communication range between two vehicles participating in V2V service.

A V2X application called vehicle-to-everything (V2X), as described above, includes the four types of (1) vehicle-to-vehicle (V2V), (2) vehicle-to-infrastructure (V2I), (3) vehicle-to-network (V2N) and (4) vehicle-to-pedestrian (V2P).

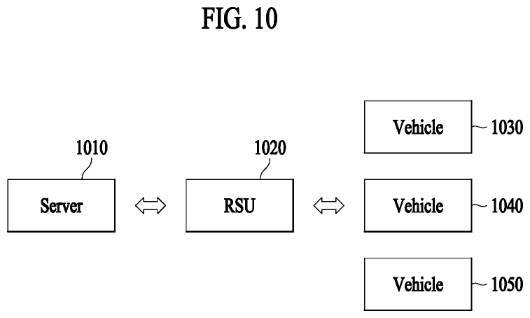

FIG. 10 is a diagram illustrating a relationship among a server, an RSU, and a vehicle according to an embodiment.

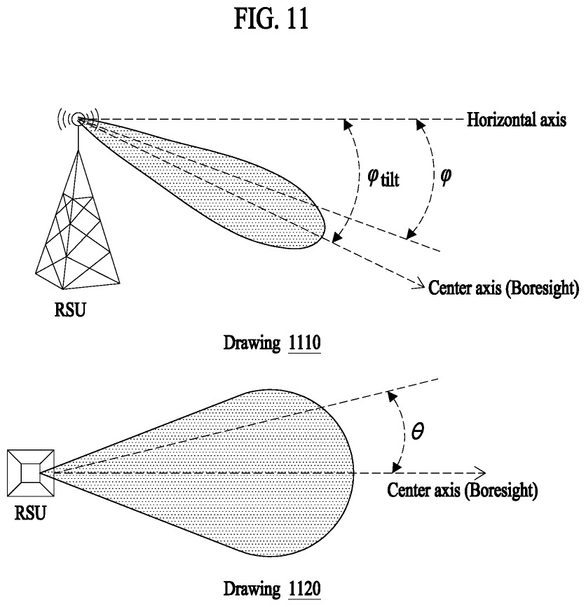

On a roadway, vehicles 1030, 1040, and 1050 may perform communication with a server 1010 through an RSU 1020. Here, the RSU 1020, an example of infrastructure, may be a communication device placed on the roadway. In this case, a beam pattern suitable for a data profile transmitted and received between the vehicle 1030 and the RSU 1020 may be formed, and data may be transmitted between the vehicle 1030 and the RSU 1020 based on the beam pattern. The beam pattern may be determined based on the data profile. Specifically, a beam pattern may be determined to satisfy a data transmission rate required for each data profile. If a platooning vehicle performing vehicle platooning is located between the vehicle 1030 and the RSU 1020, a control command for the platooning vehicle may be transmitted so that the beam pattern does not overlap the platooning vehicle. The vehicle 1030 may successfully transmit and receive, using beam information, data with the RSU 1020 in a lane in the vehicle 1030 is driving, and the server 1010 may store relevant information. In this case, the stored relevant information may be information relevant to the vehicle 1030. For example, the stored relevant information may include at least one of the following: a type of the vehicle, a height of a sensor, a distance between the vehicle and the RSU 1020, beam information (a beam pattern, a horizontal angle, a vertical angle, power, etc.), and driving-related information of the vehicle. A detailed description of the beam information will refer to FIG. 11.

After the vehicle 1030 drives in the corresponding lane, the vehicle 1040 driving in the same lane may identify the relevant information stored in the server 1010. At this point, when the vehicle 1040 transmits and receives a data profile identical to a data profile for the vehicle 1030 with respect to the RSU 1020, the vehicle 1040 may transmit and receive data with respect to the RSU 1020 through a beam pattern and power determined using the stored relevant information. If the arrangement of a platooning vehicle between the vehicle 1040 and the RSU 1020 is different from the arrangement of the platooning vehicle between the vehicle 1030 and the RSU 1020, a control command may be transmitted to adjust the arrangement of the platooning vehicle between the vehicle 1040 and the RSU 1020. If data transmission and reception between the vehicle 1040 and the RSU 1020 is successfully performed, relevant information may be stored and updated in the server 1010.

The vehicle 1050 driving in the same lane in which the vehicles 1030 and the 1040 drives may successfully transmit and receive data with respect to the RSU 1020 using the updated information, and relevant information may be stored and updated in the server 1010. That is, beam information (e.g., a horizontal angle, a vertical angle, a beam pattern, power, etc.) used in communication between the vehicles 1030, 1040, and 1050 and the RSU 1020 may be stored in the server 1010, and beam information used by following vehicles driving along the same path (lane) may be updated each time when each following vehicle passes through a corresponding infrastructure section. Accordingly, data for each lane, data for each vehicle model of a nearby platooning vehicle, and data per hour unit may be learned. Therefore, it is possible to identify beam information capable of satisfying a data transmission rate required for each data profile transmitted and received when a following vehicle passes through a corresponding infrastructure section, and the following vehicle may be capable of transmitting and receiving data with respect to the corresponding infrastructure within a short period of time using the identified beam information.

According to an embodiment, it is necessary for an emergency vehicle such as an ambulance need to transmit and receive emergency data. In this case, at least one infrastructure may exist on a predicted route of the emergency vehicle, and a server may identify beam information available for the infrastructure and the vehicle using learned data. In this case, the emergency vehicle may need to in real time transmit and receive large capacity data, such as a route to a hospital, medical equipment measurement data, a medical image, etc. with respect to the infrastructure. When a data transmission rate determined based on the identified beam information does not satisfy a data transmission rate required to transmit large capacity data in real time, a control command for a platooning vehicle may be transmitted so as to utilize an adjusted beam pattern and adjusted power. Controlling the platooning vehicle will be later described in detail. Accordingly, an ambulance is capable of accurately and quickly transmitting and receiving emergency data (e.g., a route to a hospital, medical equipment measurement data, and a medical image) using beam information.

FIG. 11 is a diagram illustrating beam information radiated from an RSU according to an embodiment.

Using a beam pattern and power, an RSU may transmit and receive data with a vehicle driving in each lane. A drawing 1110 illustrates a vertical sectional view of the beam pattern, and a drawing 1120 illustrates a horizontal sectional view of the beam pattern.

In the drawing 1110, (OHO may denote an angle between the horizontal axis and the boresight, and φ may denote an angle from the horizontal axis to an edge of the vertical sectional view of the beam pattern. In the drawing 1120, 0 may denote an angle from the boresight to an edge of the horizontal sectional view of the beam pattern. Here, a beam pattern formed by (OHO, φ, and θ is an example and may be a three-dimensional (3D) pattern. When the beam pattern formed by the drawings 1110 and 1120 arrives at a vehicle, the RSU and the vehicle may transmit and receive data with each other using the beam pattern.

Beam information including a beam pattern and power may be determined according to a data profile transmitted and received between the vehicle and the RSU. For example, beam information used when large capacity data is uplinked or downlinked in real time between the RSU and the vehicle may be different from beam information used when small capacity data is uplinked or downlinked in non-real time. In this case, a data transmission rate required for each data profile may be a minimum data transmission rate.

In this case, a different data transmission rate may be required for successful data transmission according to each data profile. When a data transmission rate determined by a beam pattern and power between the RSU and the vehicle does not satisfy a data transmission rate required for a corresponding data profile, the beam pattern and power may be adjusted. When another vehicle is driving between the vehicle and the RSU, the another vehicle may overlap a formed beam pattern and thus a data transmission rate required for each data profile transmitted and received between the RSU and the vehicle may be failed to be satisfied. Accordingly, data transmission to the vehicle from the RSU may not be performed successfully. For example, when data transmitted and received between the RSU and the vehicle (e.g., an ambulance) is real-time large capacity data (e.g., an image of a patient's inured body part, medical equipment measurement data (heart rate sensor data), a route to a hospital, etc.), a constant data transmission rate may be required for successful transmission and reception of the real-time large capacity data. Even though a data transmission rate determined by beam information satisfies the data transmission rate required for large capacity data, data transmission and reception may not be successfully performed due to overlapping of a beam pattern and another vehicle. In this case, data transmission and reception may be successfully performed using a control command for another vehicle (e.g., a platooning vehicle). Hereinafter, a description for successful data transmission and reception between a vehicle and an RSU will be provided.

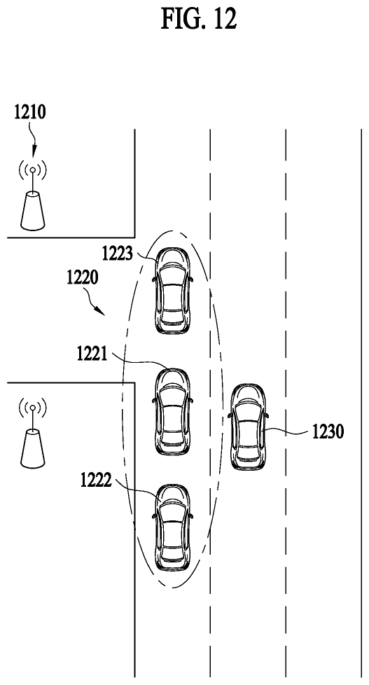

FIG. 12 is a diagram illustrating a vehicle performing vehicle platooning according to an embodiment.

Vehicle platooning refers to an operation in which a plurality of vehicles drives on a road under the same control while forming a platoon. That is, the vehicle platooning may be performed by a plurality of vehicles 1221, 1222, 1223 forming a vehicle platoon 1220 subject to the same control, and a control vehicle 1221 for controlling driving of the plurality of vehicles in the platoon, and an RSU 1210.

The control vehicle 1221 may transmit a control message to the plurality of vehicles 1222 and 1223 to control a speed and a location of each of the plurality of vehicles 1222 and 1223, so that an operation is controlled to enable vehicle platooning. In addition, the control vehicle 1221 may acquire information for vehicle platooning by communicating with the RSU 1210, and may report a state of each vehicle for the vehicle platooning to the RSU 1210.

Due to the vehicle platooning, data communication between the RSU and a vehicle 1230 driving in an adjacent lane may not be performed smoothly. Specifically, due to the plurality of vehicles forming the platoon 1220, a data transmission rate between the RSU 1210 and the vehicle 1230 may not satisfy a minimum data transmission rate. In this case, in order to satisfy the minimum data transmission rate, the RSU 1210 may transmit a message to adjust spacing formed between the plurality of vehicles 1221, 1222, and 1223. A detailed description thereof will be hereinafter provided.

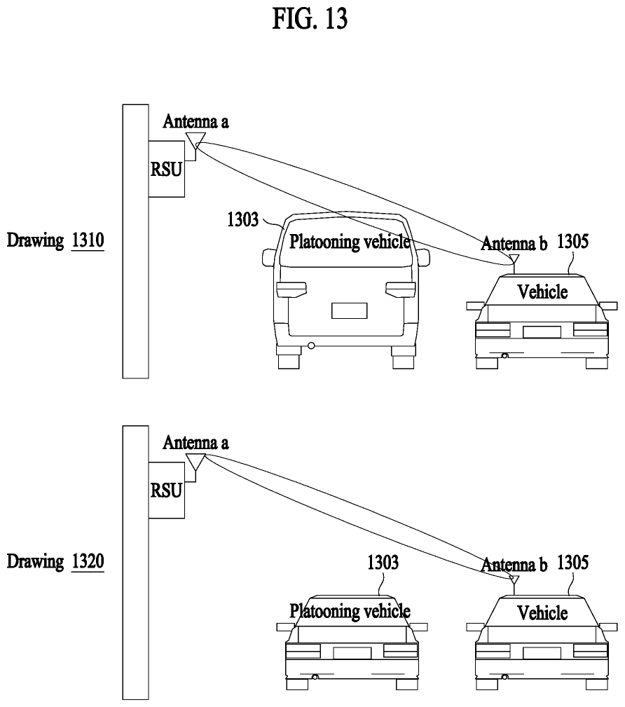

FIG. 13 is a diagram illustrating an RSU, a platooning vehicle, and a vehicle driving in an adjacent lane according to an embodiment.

A drawing 1310 illustrates an example in which a beam pattern formed between antenna a of an RSU 1301 and antenna b of a vehicle 1305 overlaps a platooning vehicle 1303, and a drawing 1320 illustrates an example in which a beam pattern formed between antenna a of the RSU 1301 and antenna b of a vehicle 1305 does not overlap the platooning vehicle 1303.

Using the beam pattern formed between the RSU 1301 and the vehicle 1305, the RSU 1301 and the vehicle 1305 may be allowed to transmit and receive data. However, if the platooning vehicle 1303 performing the vehicle platooning is located in a lane adjacent to the vehicle 1305, a beam pattern may overlap the platooning vehicle 1303, and therefore, data transmission and reception between the RSU 1301 and the vehicle 1305 may not be performed smoothly due to the platooning vehicle 1303.

In the drawing 1310, due to the platooning vehicle 1303, a data transmission rate between the RSU 1301 and the vehicle 1305 may not satisfy a minimum data transmission rate required for each data profile. In addition, in the drawing 1320, despite the presence of the platooning vehicle 1303, a data transmission rate between the RSU 1301 and the vehicle 1305 may satisfy a minimum data transmission rate required for each data profile. That is, even though there is a platooning vehicle 1303 performing vehicle platooning, a data transmission rate may differ according to heights of the RSU 1301, the vehicle 1305, and the platooning vehicle 1303.

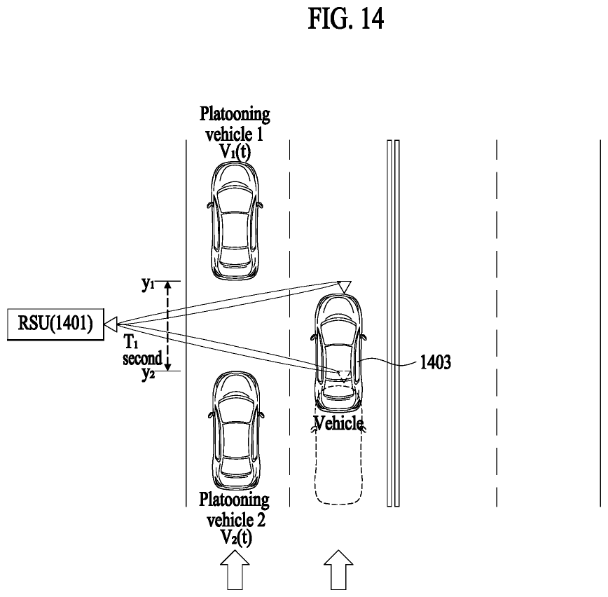

FIG. 14 is a plan view of an RSU, a platooning vehicle, and a vehicle driving in an adjacent lane according to an embodiment.

A vehicle 1403 may perform communication with an RSU 1401, which is infrastructure, in a lane in which the vehicle 1403 is now driving. In this case, data may be transmitted and received Beam between the vehicle 1403 and the RSU 1401 using a millimeter-wave (mmW) beam.

The vehicle 1403 may autonomously drive based on a predicted route for a destination. On a road included in the predicted route, at least one RSU may be arranged, and the vehicle 1403 may transmit and receive data with a server through at least one RSU. The server may identify at least one of location information, height information, or predicted route-related traffic information from at least one RSU located on the predicted route. By taking into consideration the identified information, the server may determine an RSU suitable for transmission and reception of data with the vehicle 1403. Specifically, the RSU 1401 suitable for transmission and reception of data with the autonomous vehicle 1403 may be determined using relevant information, such as speeds of platooning vehicles, locations of the platooning vehicles, spacing between platooning vehicles, heights of the platooning vehicles, a speed of an autonomous vehicle, a location of the autonomous vehicle, a height of the autonomous vehicle, a data transmission rate required for a corresponding data profile, a location of the RSU, a height of the RSU, etc.

In this case, a platooning vehicle 1 and a platooning vehicle 2 may drive between the RSU 1401 and the vehicle 1403. The platooning vehicle 1 may drive at a speed of V1(t), and the platooning vehicle 2 may drive at a speed of V2(t). Spacing between the platooning vehicle 1 and the platooning vehicle 2 may be Y1-Y2. By use of the spacing Y1-Y2, data may be transmitted and received between the RSU 1401 and the vehicle 1403. In this case, in a period of time T1 derived through Equation 1 presented below, a beam pattern between the RSU 1401 and the vehicle 1403 without overlapping of the beam pattern and the platooning vehicles.

$$T 1 = \frac{{Y}_{1} - {Y}_{2}}{{V}_{1} ( t ) - {V}_{2} ( t )} \qquad [ Equation 1 ]$$

According to an embodiment, based on a data profile transmitted and received between the RSU 1401 and the vehicle 1403, whether to allow overlapping of a beam pattern and a platooning vehicle driving in an adjacent lane may be determined. Specifically, in the case of non-real-time small capacity data, data transmission and reception may be enabled even though overlapping of a beam pattern and a platooning vehicle occurs: however, in the case of large capacity data, a communication error may occur when overlapping of a beam pattern and a platooning vehicle occurs. In this case, in the case of large capacity data, if a minimum data transmission rate is met, a communication error may not occur even though the above-described overlapping occurs. It is because a minimum data transmission rate may be satisfied as data is transmitted from the RSU 1401 to the vehicle 1403 by passing through a window of an overlapping platooning vehicle. That is, depending on whether a data transmission rate required for a transmitted and received data profile is met, data may be successfully transmitted and received between the RSU 1401 and the vehicle 1403.

For example, a predicted destination route transmitted in real time by an ambulance, medical image data for a patient, and medical equipment measurement data are large capacity data, and a minimum data transmission rate may be required for smooth communication. When a beam pattern and the platooning vehicle 1 or the platooning vehicle 2 overlap, the minimum data transmission rate may not be satisfied. In this case, in order to satisfy the minimum data transmission rate, the RSU 1401 or the vehicle 1403 may transmit a control command to the platooning vehicle 1 and the platooning vehicle 2 each performing vehicle platooning. Specifically, when a space formed by a horizontal angle of a beam pattern and a space Y1-Y2 between the platooning vehicles overlap, data transmission rate required for real-time large capacity data transmission may not be satisfied. In this case, the RSU 1401 or the vehicle 1403 may transmit a control command to each of the platooning vehicles so that the platooning vehicle 1 may be accelerated or the platooning vehicle 2 may be decelerated. Accordingly, Due to controlling of the platooning vehicle 1 and the platooning vehicle 2, a data transmission rate required for real-time large capacity data transmission may be satisfied.

In addition, a beam pattern between the RSU 1401 and the vehicle 1403 may be formed through a space generated based on a difference in height between the platooning vehicle 1 and the platooning vehicle 2. A height of the platooning vehicle 1 may be H1(t), a height of the platooning vehicle 3 may be H2(t), and a height of the vehicle 1403 may be H3(t). If a relationship of H1(t)>H3(t)>H2(t) is satisfied and if an antenna height of the RSU 1401 is between H1(t) and H2(t), the RSU 1401 may transmit data to the vehicle 1403 using the space generated based on a difference in height between the first platooning vehicle 1 and the second platooning vehicle 2. That is, the beam pattern between the RSU 1401 and the vehicle 1403 may be formed three-dimensionally (3D) not just using the horizontal spacing Y1-Y2 between the platooning vehicle 1 and the platooning vehicle 2, but also using the difference in height between the platooning vehicle 1 and the platooning vehicle 2. When a data transmission rate by a stereoscopic 3D beam pattern formed between the RSU 1401 and the vehicle 1403 satisfies a data transmission rate required for each data profile, data communication between the RSU 1401 and the vehicle 1403 may be performed successfully. When the data transmission rate by the stereoscopic 3D beam pattern does not satisfy a data transmission rate required for each data profile, the data transmission rate required for each data profile may be satisfied through a control command for the platooning vehicle 1 and the platooning vehicle 2.

Meanwhile, a vehicle may identify that platooning vehicles are driving in the vicinity, and the vehicle may transmit information regarding the platooning vehicles to an RSU. The RSU may identify a transmission rate of communication with the vehicle based on the information regarding the platooning vehicles. When the identified transmission rate does not satisfy a predetermined condition, the RSU may transmit a message for controlling driving of the platooning vehicles to at least one of the platooning vehicles. The message may include information for adjusting at least one of spacing between the platooning vehicles or speeds of the platooning vehicles, and the vehicle may be capable of smoothly performing communication with the RSU using the message. In addition, in an embodiment, the vehicle may report, to the RSU, information on another vehicle driving between the vehicle and the RSU. When it is determined, based on the reported information, that the another vehicle affects a communication environment between the vehicle and the RSU, the RSU may transmit a message for controlling the another vehicle, thereby preventing the another vehicle from overlapping between the RSU and the vehicle.

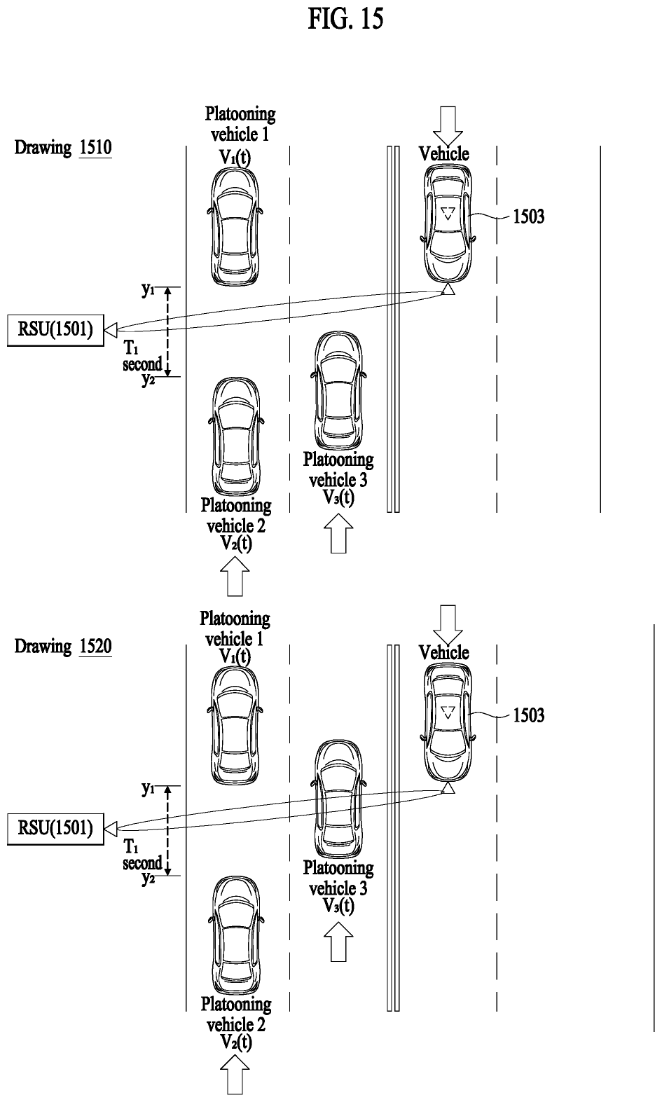

FIG. 15 is a plan view of an RSU, platooning vehicles, and a vehicle according to another embodiment.

A drawing 1510 illustrates the case where an RSU 1501 transmits and receives data to a vehicle 1503 driving in lanes of the opposite direction. The vehicle 1503 may drive along a predicted route for a destination. At least one RSU may be arranged on the predicted route, and the vehicle 1503 may communicate with a server through an RSU. The server may receive, from an RSU located in a moving route of the vehicle 1503, location information of the RSU, height information of the RSU, and traffic information. Based on the received information, the server may determine a location suitable for data transmission and reception with the vehicle 1503. Here, the traffic information may be information related to a traffic condition on a road, and may include information regarding a platooning vehicle. The server may select the RSU 1501 by taking into consideration spacing formed between platooning vehicles and a minimum data transmission rate required for each data profile. Based on a beam pattern formed between the RSU 1501 and the vehicle 1503, data may be transmitted and received. In this case, the beam pattern formed between the RSU 1501 and the vehicle 1503 may not overlap with platooning vehicles 1 to 3, as shown in the drawing 1510.

A drawing 1520 illustrates the case where the RSU 1501 transmits data through a window of the platooning vehicle 3 to the vehicle 1503 driving in a lane of the opposite direction. A minimum data transmission rate required for a data profile transmitted and received between the RSU 1501 and the vehicle 1503 may be taken into consideration. In this case, a location of the platooning vehicle 3 may be predicted by calculating a speed V3(t) of the platooning vehicle 3, and the data may be transmitted and received through the window of the platooning vehicle 3 by taking into consideration the predicted location.

In the drawing 1510, in the case where the transmitted and received data profile is taken into consideration, if the platooning vehicle 3 and the beam pattern overlap, the minimum data transmission rate may not be satisfied. In the drawing 1520, in the case where the data profile is taken into consideration, even though the platooning vehicle 3 and the beam pattern overlap, the minimum data transmission rate may be satisfied through the window of the platooning vehicle 3. If the minimum data transmission rate is not satisfied in the drawing 1520 due to overlapping of the platooning vehicle 3 and the beam pattern, a control command for reducing a speed of the platooning vehicle 3 so as to prevent the overlapping may be transmitted.

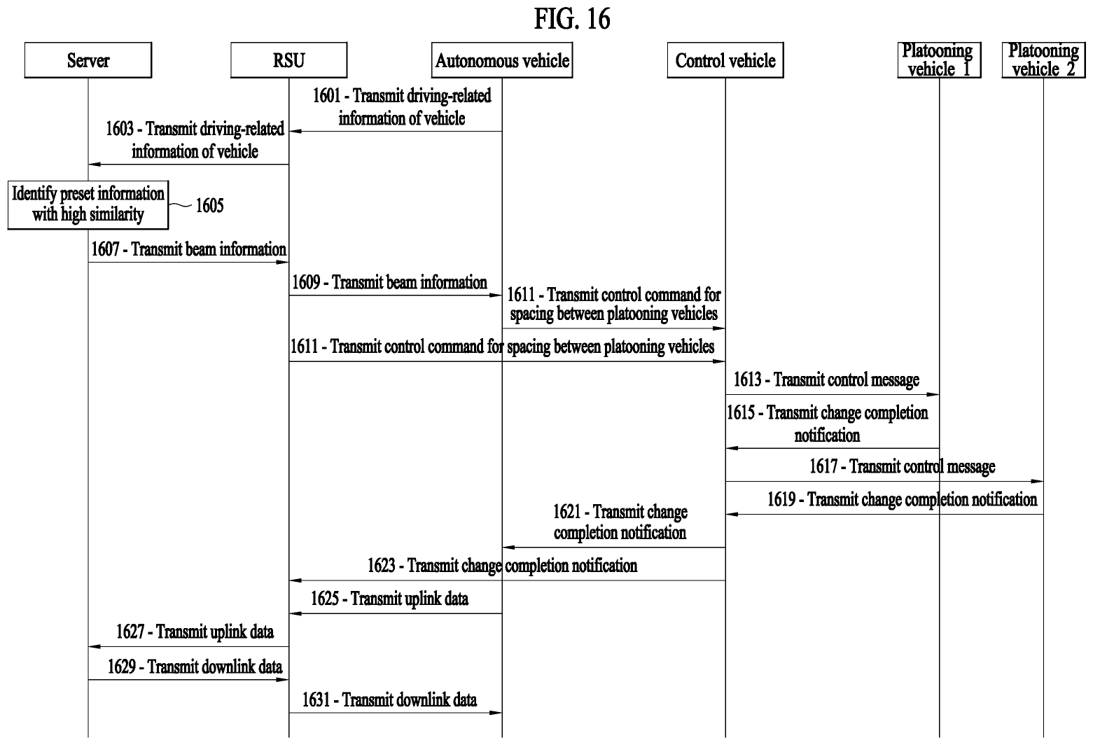

FIG. 16 is a diagram illustrating a control procedure for platooning vehicles according to an embodiment.

A vehicle may transmit driving-related information to an RSU in operation 1601, and the RSU may transmit the driving-related information to a server in operation 1603. Here, the driving-related information may include at least one of the following: information on a predicted route of the vehicle, location information of the vehicle, shape information of the vehicle, speed information of the vehicle, location information of a platooning vehicle located in an adjacent lane, shape information of the platooning vehicle, and speed information of the platooning vehicle.

The server may identify information indicating that a correspondence relationship between the received driving-related information and pre-trained information is equal to or greater than a predetermined criterion. Here, the pre-trained information may include statistical information on successful communication between another vehicle and infrastructure. Here, the infrastructure may be a communication device. For example, the server may identify pre-trained information with a similarity of 70% or more to the driving-related information. Specifically, pre-trained information with a similarity of 70% or more to a transmitted and received data profile in terms of a location, a shape, and a speed of a host vehicle and a location, a shape, and a speed of a platooning vehicle may be identified.

The pre-trained information may include beam information. The beam information may include horizontal angle information, vertical angle information, and power information, which are associated with beamforming that has been used for communication. A data transmission rate may be determined based on the horizontal angle information, the vertical angle information, and the power information. For example, horizontal angle information, the vertical angle information, and power information of a beam pattern formed when data is successfully transmitted and received may be included in the beam information. The server may transmit the beam information included in the pre-trained information satisfying a correspondence relationship equal to or greater than the predetermined criterion in operation 1607, and the RSU may transmit the beam information to the autonomous vehicle in operation 1609. In an embodiment, the beam information may include at least one of beam index information. The beam index information may be generated based on information received from the server, and beam index information corresponding to at least one beam set capable of being allocated to the autonomous vehicle based on pre-trained information with a higher similarity may be received. In addition, the autonomous vehicle may perform communication by selecting at least one of beams included in a beam set based on such information. In an embodiment, the autonomous vehicle having received the beam information may transmit a reference signal using each beam included in a beam set to at least one of another vehicle or the RSU and may select a beam based on report information received from the at least one of the another vehicle or the RSU in response to the reference signal. For example, in order to allow the vehicle to select a beam for use in uplink transmission, the RSU may transmit beam set information corresponding information on the vehicle to the vehicle based on pre-trained information. The vehicle may transmit a reference signal to the RSU based on the received beam set information. Based on the received reference signal, the RSU may feedback, to the vehicle, information on a beam suitable for uplink transmission. Based on the fed-back information, the vehicle may determine a beam to be used for uplink transmission.

A minimum data transmission rate required for a data profile transmitted and received between the autonomous vehicle and the RSU and a data transmission rate identified from the received beam information may be compared. In this case, when the data transmission rate identified from the beam information does not satisfy the minimum data transmission rate, data transmission and reception between the autonomous vehicle and the RSU may be performed based on the received beam information. Alternatively, when the data transmission rate identified from the beam information satisfies the minimum data transmission rate, the RSU or the autonomous vehicle may transmit control information to a control vehicle for controlling vehicle platooning in operation 1611. The control information may include a control command for spacing information for a platooning vehicle. Accordingly, spacing for the platooning vehicle may be controlled in accordance with the control command.

In order to cause the data transmission rate between the vehicle and the RSU to satisfy the minimum data transmission rate, at least one of a horizontal angle, a vertical angle, or power of a beam may be adjusted. A beam pattern formed by the horizontal angle or the vertical angle of the beam may overlap a platooning vehicle driving in an adjacent lane. Thus, to prevent the beam pattern from overlapping any platooning vehicle, a control command for spacing between platooning vehicle may be transmitted to the control vehicle. The control vehicle may transmit a control message to a platooning vehicle 1 in operation 1613, and the control vehicle may transmit the control message to a platooning vehicle 2 in operation 1617. That is, the control message may include control information for speeds or locations of platooning vehicles, so that a stereoscopic 3D beam pattern formed by the adjusted horizontal angle or vertical angle does not overlap a platooning vehicle. For example, in accordance with a control message, the platooning vehicle 1 located ahead of the autonomous vehicle may increase a speed or the platooning vehicle 2 located behind the autonomous vehicle may decrease a speed. Accordingly, it is possible to prevent overlapping with a stereoscopic 3D beam pattern formed by spacing between the platooning vehicle 1 and the platooning vehicle 2 and an adjusted horizontal angle or vertical angle.

The platooning vehicle 1 may transmit a change completion notification regarding a speed and a location based on the control message to the control vehicle in operation 1615, and the platooning vehicle 2 may also transmit a change completion notification regarding a speed and a location based on the control message to the control vehicle in operation 1619. After receiving relevant information from the platooning vehicle 1 and the platooning vehicle 2, the control vehicle may transmit a change completion notification to the autonomous vehicle in operation 1621 and may transmit the change completion notification even to the RSU in operation 1623.

Since the beam pattern and any platooning vehicle do not overlap due to the speed or location adjustment of the platooning vehicle 1 and the platooning vehicle 2, the data transmission rate between the autonomous vehicle and the RSU may satisfy the minimum data transmission rate. Accordingly, the autonomous vehicle may transmit uplink data to the RSU in operation 1625, and the RSU may transmit the uplink data to the server in operation 1627. In addition, the server may transmit downlink data to the RSU in operation 1629, and the RSU may transmit the downlink data to the autonomous vehicle in operation 1631. In this case, after successful data transmission and reception, relevant information may be stored and updated in the server, and a following vehicle may utilize the updated information.

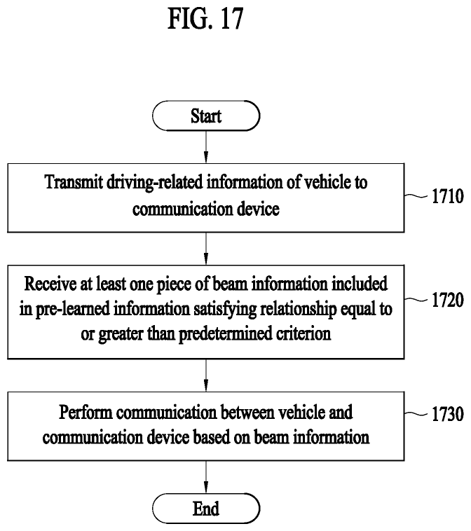

FIG. 17 is a flowchart of a data communication method according to an embodiment.

In operation 1710, a vehicle may transmit driving-related information to infrastructure which is a communication device. In operation 1720, the vehicle may receive at least one of beam information included in pre-trained information satisfying a correspondence relationship equal to or greater than the predetermined criterion with respect to the driving-related information. In operation 1730, the vehicle may communicate with the communication device based on the received beam information. The foregoing description may be applied to FIG. 17.

In this case, beam information may include at least one of horizontal angle information, vertical angle information, or power information for beamforming that uses a millimeter wave bandwidth.

Whether a data transmission rate between the vehicle and the communication device based on the beam information satisfies a data transmission rate required for each data profile may be determined. In this case, a different data transmission rate may be required according to a data profile transmitted and received between the vehicle and the communication device. For example, when data transmitted and received between an emergency vehicle and an RSU, which is a communication device, is large capacity data (e.g., an image of a patient's injured body part, image equipment measurement data (heart rate sensor data), a route to a hospital, etc.) and when such data is small capacity data, different data transmission rates may be required.

If the required transmission rate is not satisfied, control information may be transmitted to a platooning vehicle using V2X. In this case, the control information may include information on spacing between platooning vehicles, and the information on the spacing may be determined by taking into consideration a data transmission rate and a beam pattern according to beam information. For example, the control information may include information for controlling platooning vehicles so that a beam pattern formed between the vehicle and the communication device based on beam information do not overlap. When a required data transmission rate is not satisfied because the beam pattern and the platooning vehicles overlap, beam pattern not overlapping spacing may be included in the control information, and spacing between the platooning vehicles may be adjusted by the control information. For example, the spacing between the platooning vehicles may be adjusted as speeds of the platooning vehicles are adjusted. In this case, the space to be adjusted may be determined by taking into consideration a beam pattern.

Here, a correspondence relationship equal to or greater than a predetermined criterion may include a relationship in which a correspondence relationship between past information included in previously trained information and driving-related information corresponds to or exceed the predetermined criterion. The past information may include information regarding communication previously successfully performed between the vehicle and the communication device, and the previously trained information may be updated based on the past information.

A past vehicle may have successfully performed communication with the communication device using a channel. In this case, uplink or downlink-related beam information may be included in at least one of beam information. Uplink-related beam information may be identified based on information regarding a channel state that is identified by the communication device based on a reference signal transmitted from another vehicle. Downlink-related beam information may be identified based on information regarding a channel state that is reported by another device based on a reference signal transmitted from the communication device.

A different data transmission rate may be required for each channel. Channels corresponding to a plurality of beams may be measured, a data transmission rate for each channel may be determined, and a beam most suitable for communication may be used. Specifically, in the case of an uplink, a channel may be determined based on a pilot signal matrix transmitted from a past vehicle to the communication device, and, in the case of a downlink, a channel may be determined based on a channel matrix transmitted from the communication device to the past vehicle and a channel feedback transmitted from the past vehicle to the communication device.

According to an embodiment, when there is previously trained information satisfying a correspondence relationship equal to or greater than a predetermined criterion with respect to driving-related information, communication between a vehicle and infrastructure may be performed based on beam information included in the previously trained information. For example, communication between a vehicle and an RSU may be performed based on beam information included in previously trained information corresponding to a similarity equal to or greater than 70%. In this case, when a minimum data transmission rate is not satisfied, a control command for platooning vehicles may be transmitted so as to cause the minimum data transmission rate to be satisfied. When data transmission and reception is performed successfully, relevant information may be stored and updated in a server and following vehicles may perform data communication using the updated information.

According to yet another embodiment, a vehicle may transmit a pilot signal matrix to an RSU, which is infrastructure installed on a road, and the RSU may feedback a channel matrix corresponding to the pilot signal matrix to the vehicle. Based on the pilot signal matrix and the channel matrix corresponding thereto, a beam pattern between the RSU and the vehicle may be determined and a data transmission rate corresponding to the beam pattern may be determined. In this case, a minimum data transmission rate required for each data profile may differ.

For example, in the case of a downlink or an uplink, when a data transmission rate corresponding to a beam pattern satisfies a minimum data transmission rate, data communication may be performed using the beam pattern. Alternatively, when the data transmission rate corresponding to the beam pattern does not satisfy the minimum data transmission rate, a horizontal angle and a vertical angle of the beam pattern may be adjusted upward and power of the beam pattern may be adjusted upward. As a result, a data transmission rate resulting from the use of the adjusted beam pattern may increase and thus satisfy the minimum data transmission rate. In this case, when the adjusted beam pattern and a platooning vehicle driving in an adjacent lane overlap, a vehicle or an RSU may transmit a control command to a control vehicle, performing vehicle platooning, through a V2V message. Accordingly, since the adjusted beam pattern does not overlap the platooning vehicles as spacing between platooning vehicles is secured, the minimum data transmission rate may be satisfied. As a result, a downlink or uplink data may be successfully transmitted from the RSU to the vehicle. When data transmission is successfully performed, relevant information may be stored and updated in a server and following vehicles may perform data transmission using the updated information.

According to an embodiment of the present disclosure, there are one or more effects, as below.

First, it is possible to accurately and rapidly perform communication between a vehicle and infrastructure using beam information included in pre-trained information that satisfies a correspondence relationship equal to or greater than a predetermined criterion with respect to driving-related information of the vehicle.

Second, when a data transmission rate required for a data profile is not satisfied due to platooning vehicles performing vehicle platooning, it is possible to accurately and rapidly perform communication between the vehicle and the infrastructure by transmitting a control command for controlling the platooning vehicles.

Third, it is possible to accurately and rapidly perform communication because a data transmission rate required for each data profile is satisfied as speeds or locations of the platooning vehicles are controlled so that the platooning vehicle do not overlap a stereoscopic 3D beam pattern.

The effects of the present disclosure are not limited to the above; other effects that are not described herein will be clearly understood by the persons skilled in the art from the following claims.

While the present disclosure has been particularly shown and described with reference to preferred embodiments thereof, it will be understood by those skilled in the art that various changes in form and details may be made therein without departing from the spirit and scope of the present disclosure as defined by the appended claims. The preferred embodiments should be considered in descriptive sense only and not for purposes of limitation. Therefore, the scope of the present disclosure is defined not by the detailed description of the present disclosure but by the appended claims, and all differences within the scope will be construed as being included in the present disclosure.

What is claimed is:

1. A data communication method comprising:
transmitting, to a communication device, driving-related information of a vehicle;
receiving, by the communication device and based on a relationship between pre-trained information and the driving-related information being equal to or greater than a predetermined criterion, beam information included in the pre-trained information; and
performing, based on the received beam information, communication between the vehicle and the communication device.

2. The data communication method of claim 1, wherein:
the beam information comprises at least one of horizontal angle information, vertical angle information, or power information, and is used to form a beam with a millimeter wave bandwidth, and
the driving-related information comprises at least one of location information of the vehicle, shape information of the vehicle, speed information of the vehicle, location information of platooning vehicles located in a lane adjacent to the vehicle, shape information of the platooning vehicles, or speed information of the platooning vehicles.

3. The data communication method of claim 2, wherein:
the platooning vehicles are located between the vehicle and the communication device, and configured to perform vehicle platooning, and
the communication device is configured to transmit, based on information regarding a channel state between the vehicle and the communication device satisfying a predetermined condition, control information for controlling the platooning vehicles.

4. The data communication method of claim 3, wherein the predetermined condition comprises a condition in which a data transmission rate between the vehicle and the communication device does not satisfy a data transmission rate required for a data profile.

5. The data communication method of claim 3, wherein:
the control information comprises information of spacing between the platooning vehicles, and
the information of the spacing between the platooning vehicles is determined based on a data transmission rate between the vehicle and the communication device and a beam pattern according to the beam information.

6. The data communication method of claim 1, wherein the beam information is identified based on a result of communication between another vehicle and the communication device, and wherein the result of communication corresponds to the driving-related information of the vehicle.

7. The data communication method of claim 6, wherein:
the beam information comprises uplink-related beam information or downlink-related beam information,
the uplink-related beam information is identified based on information of a channel state that is identified by the communication device using a reference signal transmitted from another vehicle, and
the downlink-related information is identified based on information of a channel state that is reported by another device using a reference signal transmitted from the communication device.

8. A data communication method performed in a computing device, the method comprising:
receiving, by a communication device, driving-related information of a vehicle;
identifying, by the communication device and based on a relationship between pre-trained information and the driving-related information being equal to or greater than a predetermined criterion, beam information included in the pre-trained information; and
transmitting, based on a data transmission rate between the vehicle and a communication device and relevant to the beam information not satisfying a transmission rate required for a data profile, control information to platooning vehicles located in a lane adjacent to the vehicle through vehicle-to-everything (V2X) communication.

9. The data communication method of claim 8, wherein:
the platooning vehicles are located between the vehicle and the communication device, and configured to perform vehicle platooning between the vehicle and the communication device,
the beam information comprises at least one of horizontal angle information, vertical angle information, or power information, and is used to form a beam with a millimeter wave bandwidth, and
the driving-related information comprises at least one of location information of the vehicle, shape information of the vehicle, or speed information of the vehicle, location information of the platooning vehicles located in a lane adjacent to the vehicle, shape information of the platooning vehicles, or speed information of the platooning vehicles.

10. The data communication method of claim 8, wherein:
the control information comprises information of spacing between the platooning vehicles,
the information of the spacing between the platooning vehicles is determined based on the data transmission rate between the vehicle and the communication device and a beam pattern according to the beam information,
the beam information comprises uplink-related beam information or downlink-related beam information,
the uplink-related beam information is identified based on information of a channel state that is identified by the communication device using a reference signal transmitted from another vehicle, and
the downlink-related information is identified based on information of a channel state that is reported by another device using a reference signal transmitted from the communication device.

11. A vehicle comprising:
a communicator configured to:
transmit, to a communication device, driving-related information of the vehicle, and
receive, by the communication device and based on a relationship between pre-trained information and the driving-related information being equal to or greater than a predetermined criterion, beam information included in the pre-trained information; and
a processor configured to identify the driving-related information of the vehicle and determine a communication between the vehicle and the communication device based on the beam information.

12. The vehicle of claim 11, wherein:
the beam information comprises at least one of horizontal angle information, vertical angle information, or power information, and is used to form a beam with a millimeter wave bandwidth, and
the driving-related information comprises at least one of location information of the vehicle, shape information of the vehicle, or speed information of the vehicle, location information of platooning vehicles located in a lane adjacent to the vehicle, shape information of the platooning vehicles, or speed information of the platooning vehicles.

13. The vehicle of claim 12, wherein:
the platooning vehicles are located between the vehicle and the communication device, and configured to perform vehicle platooning, and
the processor is configured to transmit, based on information of a channel state between the vehicle and the communication device satisfying a predetermined condition, control information for controlling the platooning vehicles.

14. The vehicle of claim 13, wherein:
the predetermined condition comprises a condition in which a data transmission rate between the vehicle and the communication device does not satisfy a transmission rate required for a data profile.

15. The vehicle of claim 13, wherein:
the control information comprises information of spacing between the platooning vehicles, and
the information of the spacing between the platooning vehicles is determined based on a data transmission rate between the vehicle and the communication device and a beam pattern according to the beam information.

16. The vehicle of claim 11, wherein the beam information is identified based on a result of communication between another vehicle and the communication device, and wherein the result of communication corresponds to the driving-related information of the vehicle.

17. The vehicle of claim 16, wherein:
the beam information comprises uplink-related beam information or downlink-related beam information,
the uplink-related beam information is identified based on information of a channel state that is identified by the communication device using a reference signal transmitted from the another vehicle, and
the downlink-related information is identified based on information of channel state that is reported by another device using a reference signal transmitted from the communication device.
